(19) United States
(12) Patent Application Publication
(10) Pub. No.: US 2026/0268386 A1
(43) Pub. Date: Sep. 10, 2026

(54) APPARATUS AND METHOD OF SUPPORTING ELECTRONIC COMMERCE SEARCH

(71) Applicant: Bucketplace Co., Ltd., Seoul (KR)

(72) Inventors: Jung Bae PARK, Daejeon (KR); Heon Seok JANG, Seongnam-si (KR)

(73) Assignee: Bucketplace Co., Ltd., Seoul (KR)

(21) Appl. No.: 19/553,313

(22) Filed: Feb. 28, 2026

(30) Foreign Application Priority Data
Mar. 5, 2025 (KR) 1020250027980

(51) Int. Cl. G06Q 30/0601; G06N 20/00

(52) U.S. Cl. CPC G06Q 30/06311; G06N 20/00

(57) ABSTRACT

The electronic commerce search support apparatus includes: a training processor for training an hp extraction unit that extracts hyper-parameters (hp) configured in a transformation function that converts training data based on user interaction data related to electronic commerce into search requests of the electronic commerce, the hp extraction unit for extracting hyper-parameters for evaluation from the trained hyper-parameters based on a plurality of search performance indicators corresponding to search results based on the trained hyper-parameters, and an hp evaluation unit for evaluating search results derived by configuring the extracted hyper-parameters in a transformation of search requests of test data based on the interaction data through the transformation function, and selecting and storing optimized hyper-parameters from the extracted hyper-parameters.

### CROSS-REFERENCE TO RELATED APPLICATION

This application claims priority from and the benefit of Korean Patent Application No. 10-2025-0027980 filed on Mar. 5, 2025, in the Korean Intellectual Property Office, the disclosure of which is incorporated herein by reference.

### BACKGROUND OF THE DISCLOSURE

### Field of the Disclosure

Example embodiments relate to an apparatus and method of supporting electronic commerce search, and more particularly to a technology for optimizing hyper-parameters (HP) for an electronic commerce search service by performing learning through Bayesian optimization and sampling with respect to a click-through rate (CTR) and a click-through conversion rate (CTCVR), which correspond to indicators of user engagement and purchase intent, thereby improving electronic commerce search performance.

### Description of the Related Art

Electronic commerce (e-commerce) search optimization has evolved toward a broader scope, and modern search frameworks integrate advanced quality measures across a range of metrics reflecting user engagement and business objectives. Search results may be aligned with such objectives through features such as the number of sales and document-query relevance.

Conventional methods generally focus on a click-through rate (CTR), which corresponds to a metric for measuring user engagement. However, focusing solely on CTR may fail to capture true purchase intent, resulting in a significant gap between user interest and actual conversion.

In conventional platforms, a product search engine plays a pivotal intermediary role by matching consumer intent with product listings. An electronic commerce search engine not only interprets and retrieves relevant products, but also serves as a primary channel between digital vendors and consumers, shapes user experience, and influences engagement and purchasing behavior across an online marketplace.

To improve both consumer engagement and vendor profitability, electronic commerce search optimization has rapidly developed from simple keyword matching into a sophisticated multi-functional framework that integrates relevance, user engagement, and business-oriented metrics. Conventional search systems have relied heavily on keyword matching algorithms, which have limitations in identifying direct lexical overlap between search keywords and product listings.

However, as introduced in recent studies, breakthrough advances in large language models (LLMs) and neural multi-modal retrieval models enable systems to process dense retrieval by measuring semantic similarity between query and document vectors. While most prior research focuses on relevance scores in hybrid search combining dense retrieval techniques, such relevance scores are typically obtained by interpreting user interaction logs and do not necessarily represent user preferences, interests, or engagement that are important in electronic commerce.

Electronic commerce search optimization has thus grown into an advanced framework integrating relevance, engagement, and business-critical indicators beyond traditional keyword-based search approaches. In the prior art, search optimization has emphasized maximizing CTR as an engagement metric; however, CTR alone is often insufficient to predict actual conversion, which is the most critical factor in electronic commerce.

To address this issue, a click-through conversion rate (CTCVR) has emerged as an essential metric for identifying purchase intent. However, learning CTCVR alone is challenging due to sample selection bias and data sparsity, since learning data derived from clicks may not generalize well to a broader space of impressions, and conversion data is limited, creating a risk of overfitting to specific items.

In conventional techniques involving dense vector retrieval and learning-based ranking, existing search or ranking methods are typically optimized for a single objective, which may result in inconsistencies among relevance, user engagement, and conversion. Such a single-objective focus limits adaptability to rapidly changing electronic commerce trends and may degrade performance in an online environment.

### SUMMARY

An object of the present invention is to improve electronic commerce search performance by optimizing hyper-parameters (HP) for an electronic commerce search service through performing learning based on Bayesian optimization and sampling with respect to a click-through rate (CTR) and a click-through conversion rate (CTCVR), which correspond to indicators of user engagement and purchase intent.

Another object of the present invention is to improve a learning speed of hyper-parameter selection by including a meta-configuration voting scheme and a cumulative learning approach, and to improve performance of a search result ranking process and electronic commerce search performance based on the improved learning speed.

Still another object of the present invention is to improve electronic commerce search performance through balanced hyper-parameter optimization that satisfies both user satisfaction and revenue objectives.

According to an embodiment of the present invention, an electronic commerce search support apparatus may include a training processor for training an HP extraction unit that extracts hyper-parameters (HP) configured in a transformation function that converts training data based on user interaction data related to electronic commerce into search requests of the electronic commerce, an HP extraction unit for extracting hyper-parameters for evaluation from the trained hyper-parameters based on a plurality of search performance indicators corresponding to search results based on the trained hyper-parameters, and an HP evaluation unit for evaluating search results derived by configuring the extracted hyper-parameters in the transformation of search requests of test data based on the interaction data through the transformation function and selecting and storing optimized hyper-parameters from the extracted hyper-parameters.

The training processor may train the hyper-parameters by applying, to the transformation function, at least one feature selected from a statistically predefined score, a lexical matching score, an embedding-based similarity score, an embedding-based user preference score, an item quality score including item sales, number of views, number of comments, or shipping method, an inverted lexical index, and an item representative vector.

The training processor may apply, among the at least one feature, a query keyword or a query category to the lexical matching score, and may apply the inverted lexical index.

The HP evaluation unit may evaluate positive hyper-parameters or negative hyper-parameters by learning at least one of a click-through rate (CTR) considering the number of clicks relative to the number of search impressions, a click-through cart-adding rate (CTCAR) considering the number of cart additions relative to the number of search impressions, and a post-click cart adding rate (CAR) considering the number of cart additions relative to the number of clicks, with respect to a click-through conversion rate (CTCVR) considering the number of purchases relative to the number of search impressions.

The HP evaluation unit may filter the evaluated positive hyper-parameters or negative hyper-parameters with respect to the number of search impressions, the number of clicks, and the number of cart additions.

The HP extraction unit may extract a hyper-parameter that exceeds a reference performance by applying the evaluated positive hyper-parameters or negative hyper-parameters to any one of the plurality of search performance indicators corresponding to search results based on the trained hyper-parameters, such that search performance exceeds a reference performance.

The HP extraction unit may perform sampling of the extracted hyper-parameters for evaluation or cumulative learning.

The HP evaluation unit may extract the test data from the interaction data and evaluate the extracted hyper-parameters to determine whether the training data and the test data overlap.

The HP evaluation unit may select the optimized hyper-parameters based on a bagging method including a voting method with respect to the extracted hyper-parameters.

According to an embodiment of the present invention, an electronic commerce search support method may include: training, by a training processor, an HP extraction unit that extracts hyper-parameters (HP) configured in a transformation function that converts training data based on user interaction data related to electronic commerce into search requests of the electronic commerce; extracting, by the HP extraction unit, hyper-parameters for evaluation from the trained hyper-parameters based on a plurality of search performance indicators corresponding to search results based on the trained hyper-parameters; and evaluating, by an HP evaluation unit, search results derived by configuring the extracted hyper-parameters in the transformation of search requests of test data based on the interaction data through the transformation function and selecting and storing optimized hyper-parameters from the extracted hyper-parameters.

The training step of training the HP extraction unit may include applying, to the transformation function, at least one feature selected from a statistically predefined score, a lexical matching score, an embedding-based similarity score, an embedding-based user preference score, an item quality score including item sales, number of views, number of comments, or shipping method, an inverted lexical index, and an item representative vector, to train the hyper-parameters.

The training step may include applying, among the at least one feature, a query keyword or a query category to the lexical matching score, and applying the inverted lexical index.

The step of evaluating the search results and selecting and storing the optimized hyper-parameters may include learning at least one of a CTR, a CTCAR, and a CAR with respect to a CTCVR to evaluate positive hyper-parameters or negative hyper-parameters, and filtering the evaluated positive hyper-parameters or negative hyper-parameters with respect to the number of search impressions, the number of clicks, and the number of cart additions.

The step of extracting hyper-parameters for evaluation or cumulative learning based on any one of the plurality of search performance indicators corresponding to search results based on the trained hyper-parameters may include extracting a next hyper-parameter according to a pre-trained or in-training sampling method based on any one of the plurality of search performance indicators and the evaluated positive hyper-parameters or negative hyper-parameters, and performing sampling of the extracted hyper-parameters for the evaluation or cumulative learning.

The step of evaluating the search results and selecting and storing the optimized hyper-parameters may further include selecting the optimized hyper-parameters based on a bagging method including a voting method with respect to the extracted hyper-parameters.

The present invention may improve electronic commerce search performance by optimizing hyper-parameters (HP) for an electronic commerce search service through performing learning based on Bayesian optimization and sampling with respect to a click-through rate (CTR) and a click-through conversion rate (CTCVR), which correspond to indicators of user engagement and purchase intent.

The present invention may improve a learning speed of hyper-parameter selection by including a meta-configuration voting scheme and a cumulative learning approach, and may improve performance of a search result ranking process and electronic commerce search performance based on the improved learning speed.

The present invention may improve electronic commerce search performance through balanced hyper-parameter optimization that satisfies both user satisfaction and revenue objectives.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating an electronic commerce search support apparatus according to an embodiment of the present invention.

FIG. 2 is a diagram illustrating a hyper-parameter optimization structure based on the electronic commerce search support apparatus according to an embodiment of the present invention.

FIG. 3 is a diagram illustrating a configuration of applying a transformation function according to changes in hyper-parameters of the electronic commerce search support apparatus according to an embodiment of the present invention.

FIG. 4 is a diagram illustrating a hyper-parameter optimization algorithm of the electronic commerce search support apparatus according to an embodiment of the present invention.

FIG. 5 is a diagram illustrating search result analysis in the electronic commerce search support apparatus according to an embodiment of the present invention.

FIG. 6 is a diagram illustrating an electronic commerce search support method according to an embodiment of the present invention.

### DETAILED DESCRIPTION OF THE DISCLOSURE

Embodiments according to the inventive concept disclosed herein are described with reference to structural and functional descriptions that are provided for purposes of illustration only. The embodiments according to the inventive concept may be implemented in various forms and should not be construed as being limited to the embodiments set forth herein.

The embodiments according to the inventive concept may be subject to various modifications and may have various forms. Accordingly, specific embodiments are illustrated in the drawings and described in detail in the present specification. However, this is not intended to limit the embodiments according to the inventive concept to the particular disclosed forms, and it should be understood that all modifications, equivalents, and alternatives falling within the spirit and technical scope of the present invention are included.

Terms such as first and second may be used herein to describe various elements, but such elements should not be limited by these terms. These terms are used only for the purpose of distinguishing one element from another. For example, a first element may be referred to as a second element without departing from the scope of the inventive concept, and similarly, a second element may be referred to as a first element.

When an element is referred to as being “connected to” or “coupled to” another element, it should be understood that the element may be directly connected or coupled to the other element, or intervening elements may be present. In contrast, when an element is referred to as being “directly connected to” or “directly coupled to” another element, it should be understood that no intervening elements are present. Expressions describing relationships between elements, such as “between” and “directly between,” or “adjacent to” and “directly adjacent to,” should be interpreted in a similar manner.

The terminology used herein is for the purpose of describing particular embodiments only and is not intended to limit the present invention. Singular expressions include plural expressions unless the context clearly indicates otherwise. As used herein, the terms “include,” “including,” “comprise,” and “comprising” specify the presence of stated features, numbers, steps, operations, elements, components, or combinations thereof, but do not preclude the presence or addition of one or more other features, numbers, steps, operations, elements, components, or combinations thereof.

Unless otherwise defined, all terms used herein, including technical and scientific terms, have the same meaning as commonly understood by one of ordinary skill in the art to which the present invention pertains. Terms defined in commonly used dictionaries should be interpreted as having meanings consistent with their meanings in the context of the relevant art and should not be interpreted in an idealized or overly formal sense unless expressly defined herein.

Hereinafter, embodiments will be described in detail with reference to the accompanying drawings. However, the scope of the patent application is not limited or restricted by such embodiments. Like reference numerals in the drawings denote like elements.

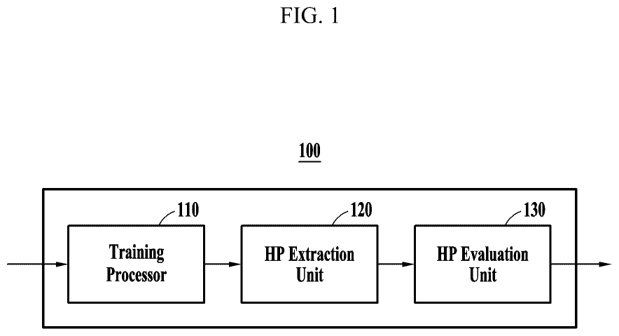

FIG. 1 is a diagram illustrating an electronic commerce search support apparatus according to an embodiment of the present invention.

FIG. 1 illustrates components of the electronic commerce search support apparatus according to an embodiment of the present invention.

Referring to FIG. 1, the electronic commerce search support apparatus 100 according to an embodiment of the present invention includes a training processor 110, an HP extraction unit 120, and an HP evaluation unit 130, and may further include a cumulative learning processor.

An apparatus of supporting electronic commerce search may be referred to as the electronic commerce search support apparatus.

The electronic commerce search support apparatus 100 according to an embodiment of the present invention implements a technology for supporting electronic commerce search by optimizing hyper-parameters (HP) used together in a transformation function used for electronic commerce search.

According to an embodiment of the present invention, the training processor 110 may train the HP extraction unit that extracts hyper-parameters configured in the transformation function that converts training data based on user interaction data related to electronic commerce into search requests of the electronic commerce.

The training processor 110 may train the HP extraction unit that extracts hyper-parameters by applying, to the transformation function, at least one feature selected from a statistically predefined score, a lexical matching score, an embedding-based similarity score, an embedding-based user preference score, an item quality score including item sales, number of views, number of comments, or shipping method (e.g., sales count, view count, comment count, cart count, number of times added to cart, share count, CTR score, CTCVR score, etc.), an inverted lexical index, and an item representative vector.

For example, with respect to the lexical matching score, a BM25 algorithm such as lexical match may be included.

The training processor 110 may apply a query keyword or a query category to the lexical matching score, apply the inverted lexical index, and apply a query representative vector to the embedding-based similarity score. For example, when only vector search is applied, the corresponding portion may be omitted and the system may still operate.

The training processor 110 may apply an item representative vector, and may apply a query representative vector and a user representative vector to the embedding-based user preference score, and may further apply the item representative vector.

The HP evaluation unit 130 may evaluate positive hyper-parameters or negative hyper-parameters by learning at least one of a click-through rate (CTR) considering the number of clicks relative to the number of search impressions, a click-through cart-adding rate (CTCAR) considering the number of cart additions relative to the number of search impressions, and a post-click cart adding rate (CAR) considering the number of cart additions relative to the number of clicks, with respect to a click-through conversion rate (CTCVR) considering the number of purchases relative to the number of search impressions.

The CTCVR may correspond to a number of purchase conversions in search relative to clicks. The CTR may indicate a frequency at which an item is clicked when exposed in search results. The CTCAR may indicate a frequency of adding an item to a cart in search results. The CAR may indicate a frequency of adding an item to a cart after a click.

The CTCVR may be used as a primary objective for learning, and the CTR, CTCAR, and CAR may be used as auxiliary objectives.

The HP evaluation unit 130 may store positive hyper-parameters or negative hyper-parameters based on Bayesian smoothing with respect to the number of search impressions, the number of clicks, and the number of cart additions.

A stored value corresponding to the positive hyper-parameters or negative hyper-parameters may be used for improved extraction of hyper-parameters by the HP extraction unit and for a subsequent meta-evaluation process or cumulative learning.

According to an embodiment of the present invention, the HP extraction unit 120 may extract hyper-parameters for evaluation or cumulative learning from the trained hyper-parameters based on search performance indicators corresponding to search results generated using the trained hyper-parameters.

The HP extraction unit 120 may extract, as a next hyper-parameter, one of the trained hyper-parameters according to a pre-trained or in-training sampling method based on the search performance indicators corresponding to search results generated using the trained hyper-parameters and the evaluated positive hyper-parameters or negative hyper-parameters.

The HP extraction unit 120 may perform sampling of the extracted hyper-parameters for evaluation or cumulative learning.

According to an embodiment of the present invention, the HP evaluation unit 130 may evaluate search results derived by configuring the extracted hyper-parameters in the transformation of search requests of test data based on interaction data through the transformation function, and may select or store optimized hyper-parameters from the extracted hyper-parameters.

The HP evaluation unit 130 may extract test data from the interaction data and evaluate previously extracted hyper-parameters to determine whether the training data and the test data overlap.

The HP evaluation unit 130 may select the optimized hyper-parameters based on a bagging method including a voting method with respect to the extracted hyper-parameters.

According to an embodiment of the present invention, a cumulative learning processor may cumulatively learn learning results corresponding to the selected and stored hyper-parameters and may remove duplicate hyper-parameters from the selected and stored hyper-parameters.

The cumulative learning processor may initialize a new learning cycle using a dataset in cumulative learning rather than initializing an observation dataset, and through this configuration, a sampler may focus on unexplored regions to minimize duplicate samples and promote exploration within a hyper-parameter space.

The cumulative learning processor may reduce computational redundancy by assigning priorities and may dynamically adapt to changes in user behavior and market trends.

The cumulative learning processor may establish an adaptive feedback mechanism to enhance robustness of hyper-parameter optimization in an evolving electronic commerce environment.

Accordingly, the present invention may improve electronic commerce search performance by optimizing hyper-parameters (HP) for an electronic commerce search service through performing learning based on Bayesian optimization and sampling with respect to a click-through rate (CTR) and a click-through conversion rate (CTCVR), which correspond to indicators of user engagement and purchase intent.

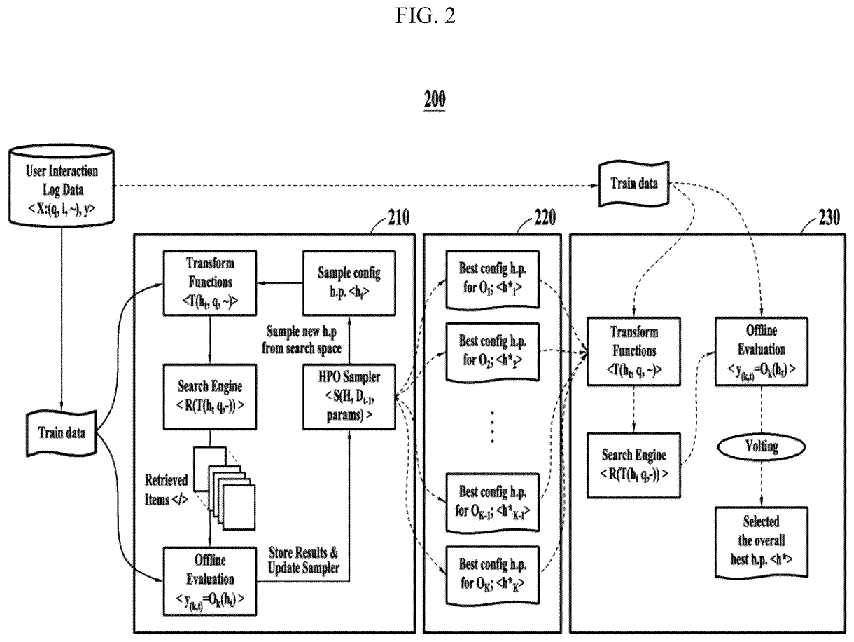

FIG. 2 is a diagram illustrating a hyper-parameter optimization structure based on the electronic commerce search support apparatus according to an embodiment of the present invention.

Referring to FIG. 2, a hyper-parameter optimization structure 200 based on the electronic commerce search support apparatus according to an embodiment of the present invention includes a training processor 210, an HP extraction unit 220, and an HP evaluation unit 230.

The training processor 210 may apply training data based on user interaction log data to a transformation function and, through transformation using sample hyper-parameters, may extract search items as search results from a search engine, and may sample hyper-parameters through evaluation of the search results.

The HP extraction unit 220 may extract high-performance hyper-parameters from the sampled hyper-parameters and may perform sampling of the extracted hyper-parameters to prepare evaluation of learning results.

The HP extraction unit 220 may, after completion of hyper-parameter optimization learning, select a set of various candidate hyper-parameter configurations based on performance of the hyper-parameters.

The HP extraction unit 220 may extract hyper-parameters to estimate online performance and to store additional meta-level evaluation information for subsequent cumulative learning.

The HP evaluation unit 230 may apply the hyper-parameters extracted by the HP extraction unit 220 and test data based on user interaction log data to the transformation function to derive search results, and may perform evaluation through voting with respect to the derived search results.

If a hyper-parameter configuration is selected solely based on training metrics, hyper-parameter optimization may become biased toward training data, and overfitting may occur because the selected hyper-parameters may not generalize well to a production environment due to sample selection bias and data sparsity.

To address this issue, the HP evaluation unit 230 may evaluate top-performing hyper-parameter configurations for unseen queries and future periods by using time-based and query-based data splitting, and may determine whether there is overlap with the training data.

The HP evaluation unit 230 may evaluate robustness of each hyper-parameter across multiple metrics and may prioritize hyper-parameters that exhibit consistent and balanced performance across objectives by using a meta-configuration voting strategy.

The approach of the HP evaluation unit 230 may integrate strengths of various configurations to select parameters that effectively generalize.

The hyper-parameter optimization structure 200 may derive an optimal hyper-parameter configuration that achieves balance.

The hyper-parameter optimization structure 200 may focus on improving relevance, ranking quality, and overall search support performance of the electronic commerce search support apparatus.

The hyper-parameter optimization structure 200 may identify a set of hyper-parameters (h∈H) that simultaneously maximizes performance of a search engine across multiple objectives O={O1, O2, . . . , OM}.

Given an observation data set D0=Ø and a ground-truth label set for each target y={y1, (·), y2, (·), . . . , ym, (·)}, the optimization approximates optimal performance iteratively by sampling and evaluating hyper-parameter configurations.

In other words, the search system may select, at each trial t=1, 2, . . . , N, a hyper-parameter configuration ht from a search space H to be evaluated.

During the optimization process, hyper-parameter configurations may be sampled by using various sampling methods such as random search, grid search, or Bayesian optimization (e.g., a Tree-structured Parzen Estimator (TPE) or a Gaussian process (GP)).

Accordingly, the present invention may improve a learning speed of optimization for hyper-parameter selection by including a meta-configuration voting method and a cumulative learning approach, and may improve a search result ranking performance and an electronic commerce search performance based on the improved learning speed.

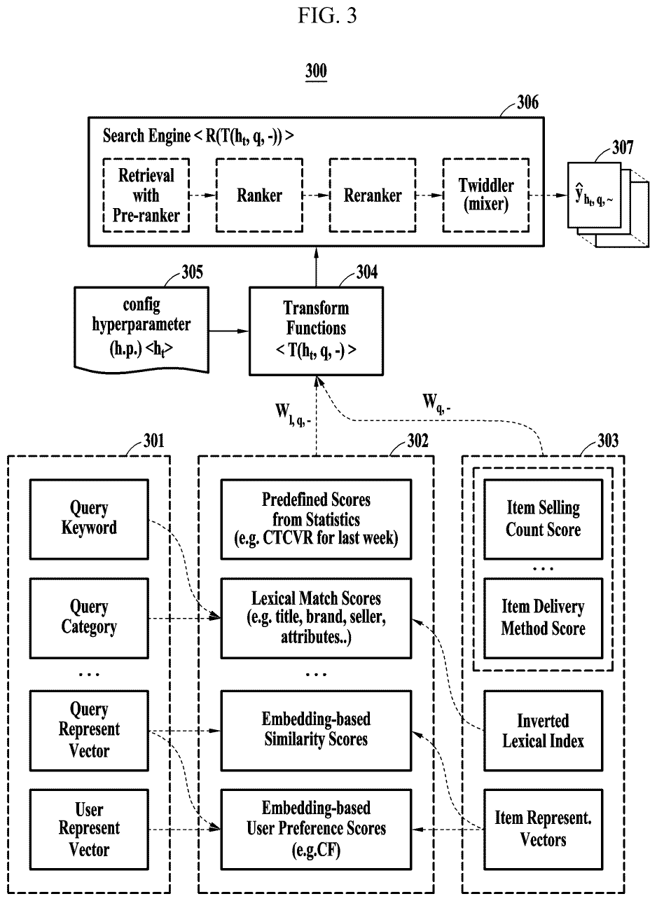

FIG. 3 is a diagram illustrating a configuration in which a transformation function is applied according to a change of hyper-parameters of an electronic commerce search support apparatus according to an embodiment of the present invention.

FIG. 3 exemplifies a configuration in which the transformation function is applied according to a change of hyper-parameters of the electronic commerce search support apparatus according to an embodiment of the present invention.

Referring to FIG. 3, a structure 300 represents a configuration in which a query request to a search engine is configured in a transformation function of the electronic commerce search support apparatus according to an embodiment of the present invention, such that the transformation function may be adjusted according to a change of hyper-parameters.

In the structure 300, at each trial, ht is sampled from a hyper-parameter configuration and a search system is evaluated on a query set.

The configuration ht affects a search process through the transformation function that adjusts an operation of the search engine according to the sampled hyper-parameters.

The structure 300 may include a change in a ranking strategy, a modification of a relevance weight, or an adjustment of a search heuristic.

In the structure 300, a query 301 is applied to a feature 302, and a feature 303 is applied to the feature 302 or to a transformation function 304.

The transformation function 304 derives search results 307 through a search engine 306 by applying the feature 302, the feature 303, and hyper-parameters 305.

Specifically, the transformation function may be represented as T(ht, q), which denotes a transformed search process according to a hyper-parameter configuration ht applied to a query q.

According to the sampled hyper-parameters, the transformation may modify a manner in which items are ranked or filtered in the search engine.

For each query q, the system generates a prediction (item ranking), and relevance or quality metrics of the items are evaluated using respective targets.

The metric for the target may be calculated based on the predicted ranking y\hat{ }ht,q,(19 ) and compared with the ground-truth label ym,q,(·), and may be formulated as zt,m,q=0k (ym,q,(·), y\hat{ }ht,q,(·)

Thereafter, performance evaluations for all queries are aggregated to generate a performance metric for each target.

The aggregated metrics are used to update an optimization process so as to guide a search for better hyper-parameter configurations.

The process is iteratively continued until convergence, and upon convergence, an objective is to select a hyper-parameter configuration that optimizes trade-offs among a plurality of objectives.

The structure 300 may be a novel hyper-parameter optimization framework specifically tailored for an electronic commerce search service focusing on objectives such as CTR and CTCVR, which are essential indicators of user engagement and purchase intent.

The structure 300 implements multi-objective hyper-parameter optimization in electronic commerce search and ranking tasks.

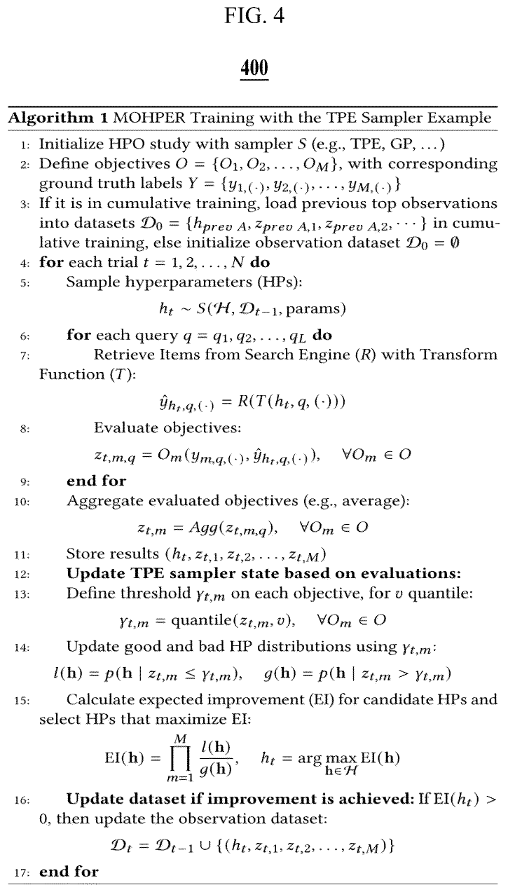

FIG. 4 is a diagram illustrating a hyper-parameter optimization algorithm of the electronic commerce search support apparatus according to an embodiment of the present invention.

FIG. 4 exemplifies a hyper-parameter optimization algorithm of the electronic commerce search support apparatus according to an embodiment of the present invention.

Referring to FIG. 4, an algorithm 400 represents an overall summary algorithm using a TPE sampler.

According to the algorithm 400, first, a sampler is initialized, and next, an object corresponding to ground truth data is defined.

Next, when cumulative learning is performed, cumulative learning is executed, and otherwise, initialization is performed and hyper-parameters are sampled.

Thereafter, the algorithm 400 retrieves items by using a transformation function and evaluates search results with respect to the object.

Next, the algorithm 400 aggregates evaluation results, stores the results, updates a state based on the evaluation results, and updates the hyper-parameters.

Thereafter, the algorithm 400 calculates an expected improvement (EI) for candidate hyper-parameters, selects hyper-parameters, and updates a data set, and then terminates.

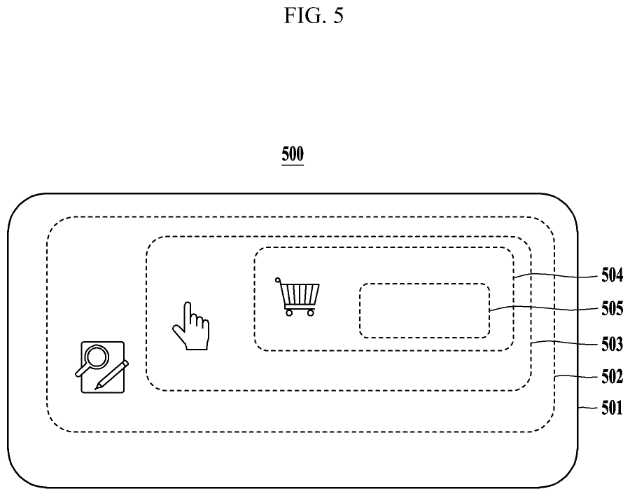

FIG. 5 is a diagram illustrating search result analysis in the electronic commerce search support apparatus according to an embodiment of the present invention.

FIG. 5 exemplifies an electronic commerce conversion funnel in item exposure according to electronic commerce search result analysis.

Referring to FIG. 5, an electronic commerce conversion funnel 500 includes an entire potential search target space 501 in production, an inference space 502 through search results, a click or desire space 503, a cart-adding space 504, and a conversion space 505.

Data corresponding to the desire space 503 and the cart-adding space 504 may be regarded as auxiliary training spaces of the conversion space 505 corresponding to a training space.

In order to enhance user engagement and sales in electronic commerce while addressing sample selection bias and data sparsity, it is essential to mine user interaction logs including clicks and conversions per impression.

Based on the electronic commerce conversion funnel 500, with respect to a click-through conversion rate (CTCVR) considering the number of purchases relative to the number of search impressions, a click-through rate (CTR) considering the number of clicks relative to the number of search impressions, a click-through cart-adding rate (CTCAR) considering the number of cart additions relative to the number of search impressions, and a post-click cart adding rate (CAR) considering the number of cart additions relative to the number of clicks may be used.

The CTCVR may be a primary objective, and the CTR, CTCAR, and CAR may be used as auxiliary objectives to mitigate selection bias and sparsity.

Labels of the items may be derived from statistics for each objective and may be used as thresholds for positive or negative scores with respect to the corresponding objective. Here, the threshold may be an evaluated result value of previously learned hyper-parameters (HP) or a preset arbitrary variable.

Although naive statistical ratios may be used, the scores may be further refined by filtering based on the number of impressions and Bayesian smoothing for rare events.

According to the metric calculation zt,m,q the metrics are aggregated over all queries, and hyper-parameter optimization performs multi-objective tuning to improve engagement, conversion efficiency, and purchase intent, thereby improving search performance in electronic commerce.

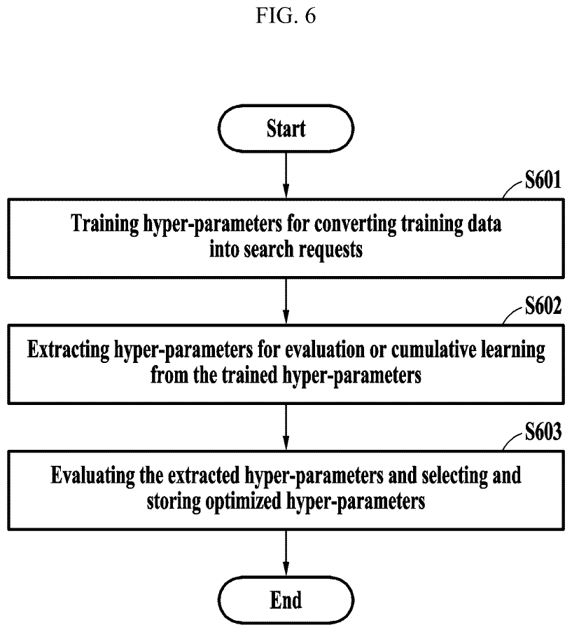

FIG. 6 is a diagram illustrating an electronic commerce search support method according to an embodiment of the present invention.

FIG. 6 exemplifies a hyper-parameter optimization procedure for improving electronic commerce search performance in the electronic commerce search support method according to an embodiment of the present invention.

Referring to FIG. 6, in step S601, the electronic commerce search support method according to an embodiment of the present invention trains an HP extraction unit that extracts hyper-parameters for converting training data into search requests.

A method of supporting electronic commerce search may be referred to as the electronic commerce search support method.

That is, the electronic commerce search support method according to an embodiment of the present invention may train an HP extraction unit that extracts hyper-parameters (HP) configured in a transformation function that converts training data based on user interaction data related to electronic commerce into search requests of the electronic commerce.

In step S602, the electronic commerce search support method according to an embodiment of the present invention extracts hyper-parameters for evaluation from the trained hyper-parameters.

That is, the electronic commerce search support method according to an embodiment of the present invention may extract hyper-parameters for evaluation from the trained hyper-parameters based on a plurality of search performance indicators corresponding to search results based on the trained hyper-parameters.

In step S603, the electronic commerce search support method according to an embodiment of the present invention evaluates the extracted hyper-parameters and selects and stores optimized hyper-parameters.

That is, the electronic commerce search support method according to an embodiment of the present invention may evaluate search results derived by configuring the extracted hyper-parameters in a transformation of search requests of test data based on the interaction data through the transformation function, and may select and store optimized hyper-parameters from the extracted hyper-parameters.

Accordingly, the present invention may improve electronic commerce search performance through balanced hyper-parameter optimization that satisfies both user satisfaction and revenue objectives.

the present invention represents an apparatus and method of supporting electronic commerce search as a novel multi-objective hyper-parameter optimization (hpo) framework tailored to requirements of electronic commerce search.

In particular, the present invention may optimize hyper-parameters in search support with respect to key performance indicators such as CTR, CTCAR, and CTCVR, which are important for improving user engagement and conversion in an electronic commerce system.

The present invention may effectively address inherent complexity associated with simultaneously optimizing diverse and competing indicators in electronic commerce.

Through extensive evaluation, the present invention demonstrates that the electronic commerce search support apparatus is capable of achieving superior stability, convergence, and robustness in multi-objective optimization under various sampling strategies of optimized hyper-parameters, thereby achieving substantial improvements in CTR, CTCVR, and related objectives.

The present invention may further improve performance of hyper-parameter optimization and implement multi-objective optimization for electronic commerce by providing measurable gains in relevance and user engagement.

The present invention may enhance adaptability of hyper-parameter optimization and provide monitoring changes between cumulative stages by developing advanced techniques such as meta-configuration voting and cumulative learning, thereby reducing sampling cost.

The apparatus described above may be implemented by hardware components, software components, and/or a combination of hardware components and software components.

For example, the apparatus and components described in the embodiments may be implemented using one or more general-purpose computers or special-purpose computers, such as, for example, a processor, a controller, an arithmetic logic unit (ALU), a digital signal processor (DSP), a microcomputer, a field programmable array (FPA), a programmable logic unit (PLU), a microprocessor, or any other device capable of executing instructions and responding thereto.

A processing device may execute an operating system (OS) and one or more software applications executed on the operating system. The processing device may also access, store, manipulate, process, and generate data in response to execution of the software.

For convenience of understanding, the processing device may be described as being singular; however, those skilled in the art will appreciate that the processing device may include a plurality of processing elements and/or a plurality of types of processing elements. For example, the processing device may include a plurality of processors, or one processor and one controller. Other processing configurations, such as a parallel processor, are also possible.

The software may include a computer program, code, instructions, or one or more combinations thereof, and may configure the processing device to operate as desired or may instruct the processing device independently or collectively.

The software and/or data may be embodied permanently or temporarily in any type of machine, component, physical device, virtual device, computer storage medium or device, or transmitted signal wave, so as to be interpreted by the processing device or to provide instructions or data to the processing device. The software may be distributed over a networked computer system and may be stored or executed in a distributed manner. The software and data may be stored in one or more computer-readable recording media.

Although embodiments have been described above with reference to limited drawings, various modifications and variations may be made by those skilled in the art based on the above description. For example, even if the described techniques are performed in an order different from that described, and/or components of the described systems, structures, apparatuses, or circuits are combined or arranged in a manner different from that described, or are replaced or substituted with other components or equivalents, appropriate results may still be achieved.

Accordingly, other implementations, other embodiments, and equivalents to the appended claims also fall within the scope of the appended claims.

What is claimed is:

1. An electronic commerce search support apparatus comprising:
a training processor for training an HP extraction unit that extracts hyper-parameters (HP) configured in a transformation function that converts training data based on user interaction data related to electronic commerce into search requests of the electronic commerce;
an HP extraction unit for extracting hyper-parameters for evaluation from the trained hyper-parameters based on a plurality of search performance indicators corresponding to search results based on the trained hyper-parameters; and
an HP evaluation unit for evaluating search results derived by configuring the extracted hyper-parameters in the transformation of search requests of test data based on the interaction data through the transformation function, and selecting and storing optimized hyper-parameters from the extracted hyper-parameters.

2. The electronic commerce search support apparatus of claim 1,
wherein the training processor trains the hyper-parameters by applying, to the transformation function, at least one feature selected from:
a statistically predefined score, a lexical matching score, an embedding-based similarity score, an embedding-based user preference score, an item quality score including item sales, number of views, number of comments, or shipping method, an inverted lexical index, and an item representative vector.

3. The electronic commerce search support apparatus of claim 2,
wherein the training processor applies, to the lexical matching score among the at least one feature, a query keyword or a query category, and applies the inverted lexical index.

4. The electronic commerce search support apparatus of claim 1,
wherein the HP evaluation unit learns at least one of:
a click-through rate (CTR) considering the number of clicks relative to the number of search impressions,
a click-through cart-adding rate (CTCAR) considering the number of cart additions relative to the number of search impressions, and
a post-click cart adding rate (CAR) considering the number of cart additions relative to the number of clicks,
with respect to a click-through conversion rate (CTCVR) considering the number of purchases relative to the number of search impressions, to evaluate positive hyper-parameters or negative hyper-parameters.

5. The electronic commerce search support apparatus of claim 4,
wherein the HP evaluation unit stores the evaluated positive hyper-parameters or negative hyper-parameters with respect to the number of search impressions, the number of clicks, and the number of cart additions.

6. The electronic commerce search support apparatus of claim 4,
wherein the HP extraction unit extracts, as a next hyper-parameter, one of the plurality of search performance indicators corresponding to search results based on the trained hyper-parameters and the evaluated positive hyper-parameters or negative hyper-parameters, according to a pre-trained or in-training sampling method.

7. The electronic commerce search support apparatus of claim 6,
wherein the HP extraction unit performs sampling of the extracted hyper-parameters for the evaluation or cumulative learning.

8. The electronic commerce search support apparatus of claim 1,
wherein the HP evaluation unit selects the optimized hyper-parameters based on a bagging method including a voting method with respect to the extracted hyper-parameters.

9. An electronic commerce search support method comprising:
training, by a training processor, an HP extraction unit that extracts hyper-parameters (HP) configured in a transformation function that converts training data based on user interaction data related to electronic commerce into search requests of the electronic commerce;
extracting, by the HP extraction unit, hyper-parameters for evaluation from the trained hyper-parameters based on a plurality of search performance indicators corresponding to search results based on the trained hyper-parameters; and
evaluating, by an HP evaluation unit, search results derived by configuring the extracted hyper-parameters in the transformation of search requests of test data based on the interaction data through the transformation function, and selecting and storing optimized hyper-parameters from the extracted hyper-parameters.

10. The electronic commerce search support method of claim 9,
wherein the training comprises applying, to the transformation function, at least one feature selected from a statistically predefined score, a lexical matching score, an embedding-based similarity score, an embedding-based user preference score, an item quality score including item sales, number of views, number of comments, or shipping method, an inverted lexical index, and an item representative vector, to train the hyper-parameters.

11. The electronic commerce search support method of claim 10,
wherein the training comprises applying, to the lexical matching score among the at least one feature, a query keyword or a query category, and applying the inverted lexical index.

12. The electronic commerce search support method of claim 9,
wherein the evaluating and selecting comprises:
learning at least one of a CTR, a CTCAR, and a CAR with respect to a CTCVR to evaluate positive hyper-parameters or negative hyper-parameters; and
filtering the evaluated positive hyper-parameters or negative hyper-parameters with respect to the number of search impressions, the number of clicks, and the number of cart additions.

13. The electronic commerce search support method of claim 12,
wherein extracting the hyper-parameters for evaluation or cumulative learning comprises:
extracting, as a next hyper-parameter, one of the plurality of search performance indicators corresponding to search results based on the trained hyper-parameters and the evaluated positive hyper-parameters or negative hyper-parameters according to a pre-trained or in-training sampling method; and
performing sampling of the extracted hyper-parameters for the evaluation or cumulative learning.

14. The electronic commerce search support method of claim 9,
wherein selecting and storing the optimized hyper-parameters comprises selecting the optimized hyper-parameters based on a bagging method including a voting method with respect to the extracted hyper-parameters.
